(19) United States
(12) Patent Application Publication
(10) Pub. No.: US 2007/0132729 A1
(43) Pub. Date: Jun. 14, 2007

(54) Character positioning system, and method thereof

(76) Inventors: Young-Sung Son, Daejon (KR); Hyun Pak, Gyeonggi-do (KR); Bong-Jin Oh, Daejon (KR); Kyeong-Deok Moon, Daejon (KR)

Correspondence Address: LADAS & PARRY LLP, 224 SOUTH MICHIGAN AVENUE, SUITE 1600, CHICAGO, IL, 60604, US

(21) Appl. No.: 11/633,738

(22) Filed: Dec. 5, 2006

(30) Foreign Application Priority Data
Dec. 9, 2005 (KR) 10-2005-0121167

(51) Int. Cl. G09G 5/08

(52) U.S. Cl. 345/160

(57) ABSTRACT

Provided is a character positioning system, and a method thereof. The system, includes: a command data analyzer for analyzing a signal inputted from outside and performing a control command according to its kinds; a positioning device for receiving an analysis result for a certain input signal from the command data analyzer and controlling a character motion on screen; and a position information storage for storing position information of a character on screen.

### FIELD OF THE INVENTION

The present invention relates to a character positioning system, and a method thereof; and, more particularly, to a character positioning system for controlling a character motion on screen through the limited number of buttons by controlling a character through button arrangement of some buttons with dynamic functions when a character of an external output device, including a cursor, is moved according to a button which sends an input signal of an external input device, e.g., a remote controller and a joy stick.

### DESCRIPTION OF RELATED ART

A conventional technology related to a method for moving a character, i.e., a cursor, on screen by using a remote controller and a joy stick will be described hereinafter.

KR Patent Publication NO. 2005-0089630 (reference 1), published on Sep. 8, 2005, discloses a remotely pointing method. The reference 1 is a technology which can move a cursor without an individual key for moving the cursor in a remote controller by setting a plurality of number keys as a cursor moving key according to user selection, converting the selected number key as the cursor moving key when a mouse mode setting command is inputted, and moving the cursor in 8 directions according to next input of the user in case of an image displayer and the remote controller for inputting a command in the image displayer.

That is, the reference 1 can easily move the cursor by the number key without a direction key by making it possible to mutually convert the number key and the cursor moving key according to an operation mode of the remote controller.

The conventional technology can move a direction of the cursor by using a few number keys which are pre-selected, but there is a problem that the conventional technology cannot control diverse character's motions including movement of a region designated by the cursor and range control of the region.

Also, since the conventional technology moves the cursor from a present position step by step, the cursor has a long distance to move when the cursor should move on entire screen in several board games such as Korean checkers and chess. Accordingly, there is a problem that the user has to send several input signals to achieve that object.

### SUMMARY OF THE INVENTION

It is, therefore, an object of the present invention to provide a character positioning system for controlling a character motion on screen through the limited number of buttons by controlling a character through button arrangement with some buttons capable of dynamic functions when a character of an external output device including a cursor is moved according to an input signal coming from a button of an external input device, e.g., a remote controller and a joy stick.

Other objects and advantages of the invention will be understood by the following description and become more apparent from the embodiments in accordance with the present invention, which are set forth hereinafter. It will be also apparent that objects and advantages of the invention can be embodied easily by the means defined in claims and arrangements thereof.

In accordance with an aspect of the present invention, there is provided a character positioning system, including: a command data analyzer for analyzing an input signal received from an input device to generate an analysis result and performing a control command based on the input signal; a positioning device for receiving the analysis result for a certain input signal from the command data analyzer and controlling a character motion on screen based on the analysis result; and a position information storage for storing position information of a character on screen.

In accordance with another aspect of the present invention, there is provided a character positioning method of a character positioning system, the method including the steps of: a) receiving an input signal from an input device; b) analyzing the input signal to generate an analysis result and determining a control command; c) when the input signal is a function state conversion request signal, mutually converting a setting function for a corresponding button; and d) when the input signal coming is a character motion request signal, controlling a motion of a character based on position information of the character on screen and the analysis result.

### BRIEF DESCRIPTION OF THE DRAWINGS

The above and other objects and features of the present invention will become apparent from the following description of the preferred embodiments given in conjunction with the accompanying drawings, in which:

FIG. 1 shows an input device and an output device of outside which are connected to a character positioning system of the present invention;

FIG. 2 is a block diagram showing the character positioning system of the present invention;

FIG. 3 is a flowchart describing a character positioning method based on button arrangement and dynamic function assignment in the character positioning system of the present invention;

FIG. 4 shows movement of a character's position according to direction designation in accordance with an embodiment of the present invention;

FIG. 5 shows movement of the character's position by motion unit change in a state of the FIG. 4 in accordance with the embodiment of the present invention;

FIG. 6 shows movement of the character's position by the regional designation in accordance with the embodiment of the present invention; and

FIG. 7 is a block diagram showing movement of the character's position by the motion unit change in a state of FIG. 6.

### DETAILED DESCRIPTION OF THE INVENTION

Other objects and advantages of the present invention will become apparent from the following description of the embodiments with reference to the accompanying drawings. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

The present invention can easily control character's motions by limited buttons such as a function key, a number key, and a direction key of an input device by assigning dynamic functions to some buttons to conveniently move a direction of a character, i.e., a cursor, and a designated region, i.e., a region of a certain size selected on screen, and extend/reduce the region, and inputting a control command through arrangement of a plurality of buttons. Herein, assigning dynamic functions to some buttons means inputting a control command, which are different from each other according to a setting state.

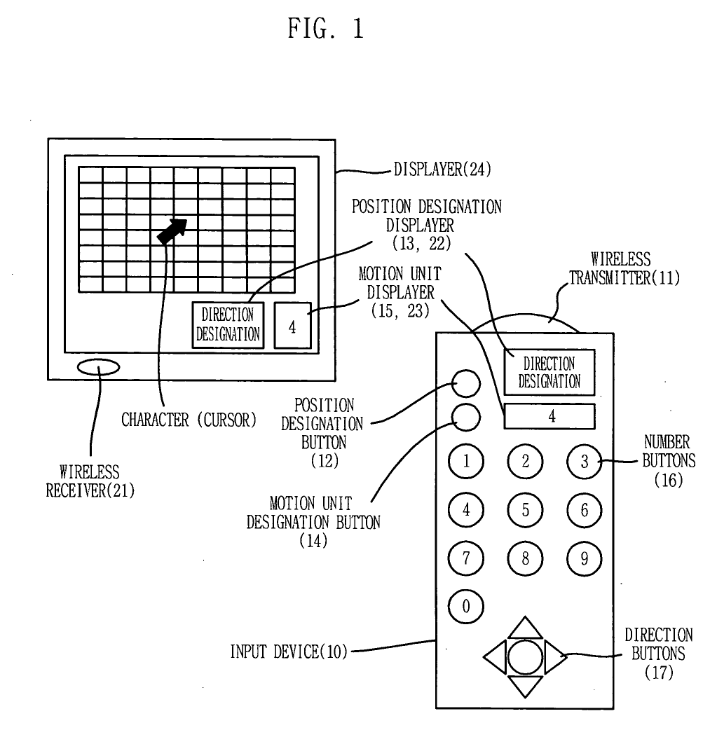

FIG. 1 shows an input device and an output device of outside which are connected to a character positioning system of the present invention.

The character positioning system of the present invention is connected to an input device 10 having a function key, a number key and a direction key, and an output device 20 for displaying diverse information on screen.

The output device 20 is connected to the character positioning system through wire, and the input device 10 wirelessly transmits/receives a signal to/from the output device 20. That is, the input device 10 transmits an input signal coming from a button of a user to a wireless receiver 21 of the output device 20 through a wireless transmitter 11 of an inside. The transmitted button input signal is analyzed by the character positioning system and displayed on screen.

The input device 10 includes a wireless transmitter 11 for wirelessly transmitting a signal, a position designation button 12 where two functions of direction designation and regional designation are mutually converted, a position designation displayer 13 for displaying a function state of the position designation button 12, i.e., the direction designation or regional designation, a motion unit designation button 14 for inputting a motion unit when a character and a designated region are moved, a motion unit displayer 15 for displaying a motion unit, which is “4” (designated by the motion unit designation button 14), a plurality of number buttons 16 and a plurality of direction buttons 17.

The position designation button 12 has dynamic functions of “direction designation” and “regional designation”. Whenever the position designation button 12 is inputted, the functions of “direction designation” and “regional designation” are mutually converted.

A predetermined control command is inputted to the character positioning system by arrangement of the position designation button 12, the motion unit designation button 14, the number buttons 16 and the direction buttons 17.

Each input signal is analyzed by the character positioning system.

The output device 20 includes an wireless receiver 21 for wirelessly receiving a signal, a position designation displayer 22 for displaying a state of the present position designation function such as “direction designation” or “regional designation”, a motion unit displayer 23 for displaying a motion unit, which is “4” (designated in a present time) and a displayer 24 for displaying diverse information including character information on screen.

The wireless receiver 21 transmits the input signal coming from the button of the user transmitted from the wireless transmitter 11 of the input device 10 to the character positioning system of the present invention. The displayer 24 displays the screen by control of the character positioning system.

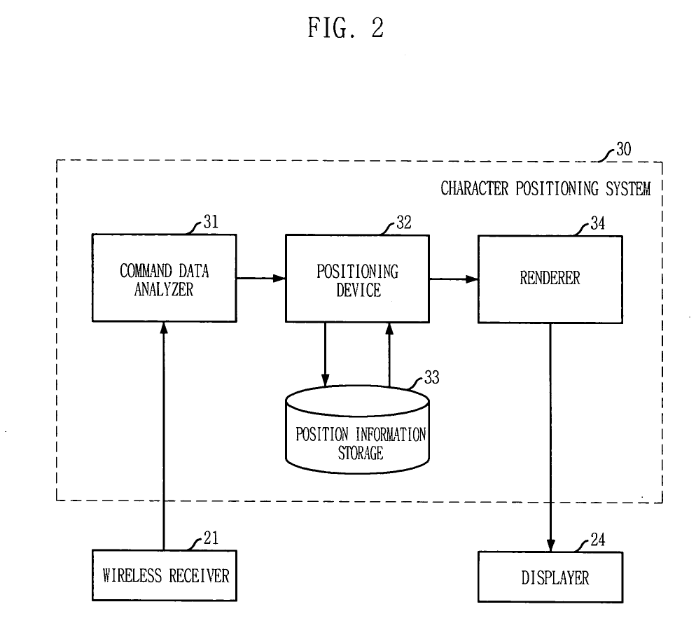

FIG. 2 is a block diagram showing the character positioning system of the present invention.

The character positioning system of the present invention includes a command data analyzer 31 for analyzing the input signal coming from the button transmitted from the wireless receiver 21, a positioning device 32, position information storage 33, and a renderer 34 for rendition.

The positioning device 32 controls motions of a character and a designated region, which are called a character, based on an analysis result of the command data analyzer 31. For example, the positioning device 32 controls movement of characters and extension/reduction of the region.

The position information storage 33 stores coordinates, i.e., position information of a present character cursor including a general character and designated region on screen.

The command data analyzer 31 analyzes the input signal coming from the button transmitted from the wireless receiver 21, and determines whether the input signal coming from the button is a character motion request signal according to input of the number buttons 16 or/and the direction buttons 17, or a function state conversion request signal according to input of the position designation button 12 or/and the motion unit designation button 14. That is, the command data analyzer 31 determines a kind of the inputted control command referring to a setting state based on the pre-inputted button input signal.

When it turns out that the input signal coming from the button is the character motion request signal, the command data analyzer 31 transmits the analysis result to the positioning device 32 such that the character on screen can be moved in case of a general character and the designated region, or the region can be extended/reduced in case of the designated region by referring to a present character's position stored in the position information storage 33.

When it turns out that the input signal coming from the button is the function state conversion request signal, the command data analyzer 31 converts the function of the button. That is, the command data analyzer 31 dynamically assigns a function to the button, i.e., dynamically analyzes each button input signal referring to the pre-determined state to convert an input signal for the position designation button 12 of the input device 10 from “direction designation” to “regional designation”, or from “regional designation” to “direction designation”. Otherwise, it is set up such that an input signal for the motion unit designation button 14 can be recognized as an input signal for a next predetermined number. For example, it is set up to recognize a conventional number “4” as a new number “0”.

When the character's position designation request signal is inputted, the positioning device 32 corrects a position of the character based on the analysis result transmitted from the command data analyzer 31, and transmits the result to the renderer 34. The positioning device 32 calculates a position of a new character including a general character and a designated region referring to coordinates, i.e., the present character's position information stored in the position information storage 33.

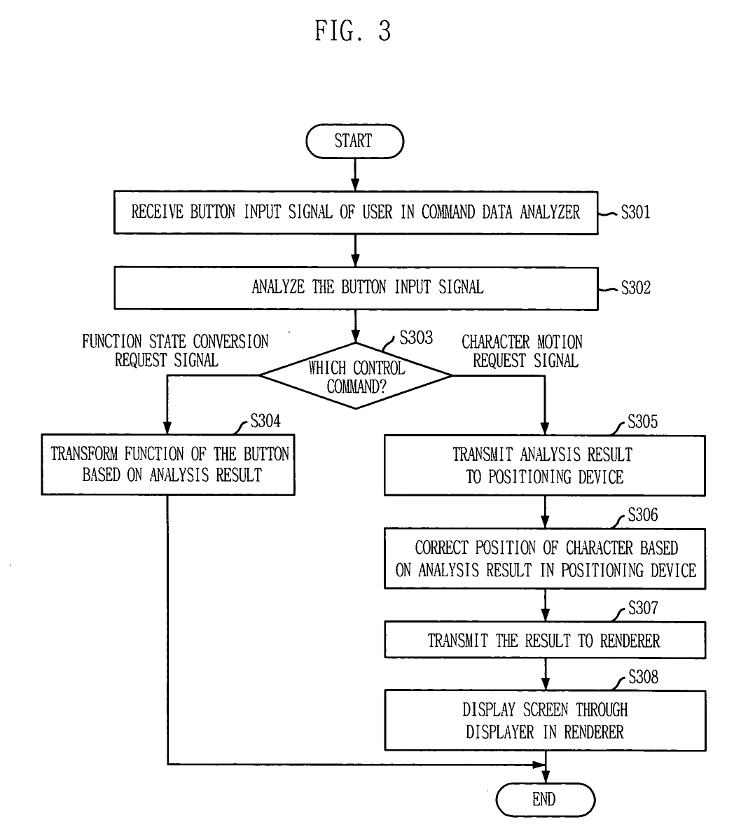

FIG. 3 is a flowchart describing a character positioning method based on button arrangement and dynamic function assignment in the character positioning system of the present invention.

The command data analyzer 31 receives an input signal coming from a button of the user at step S301. That is, the command data analyzer 31 receives the input signal for diverse buttons included in the input device 10 from the wireless receiver 21.

The command data analyzer 31 analyzes the input signal coming from the button at step S302 and determines a control command at step S303. That is, it is determined whether the input signal coming from the button is a character motion request signal or a function state conversion request signal.

When it turns out that the input signal coming from the button is the function state conversion request signal, a function of the button is transformed based on the analysis result at step S304. That is, a function of the position designation button 12 is converted from “direction designation” to “regional designation”, or from “regional designation” to “direction designation”. Otherwise, it is set up to recognize the input of the motion unit designation button 14 as an input signal for a predetermined new number. Subsequently, the logic flow ends.

When it turns out that the input signal coming from the button is the character motion request signal, the analysis result is transmitted to the positioning device 32 at step S305.

The positioning device 32 corrects the position of the character based on the transmitted analysis result at step S306 and transmits the result to the renderer 34 at step S307. Subsequently, the renderer 34 displays a screen through the displayer 24 at step S308. The renderer 34 displays the character in a corrected position.

The positioning device 32 can move coordinates of the character including a general character and a designated region, or extend/reduce the designated region. The positioning device 32 calculates a new position referring to the coordinates, i.e., the present position of the character stored in the position information storage 33.

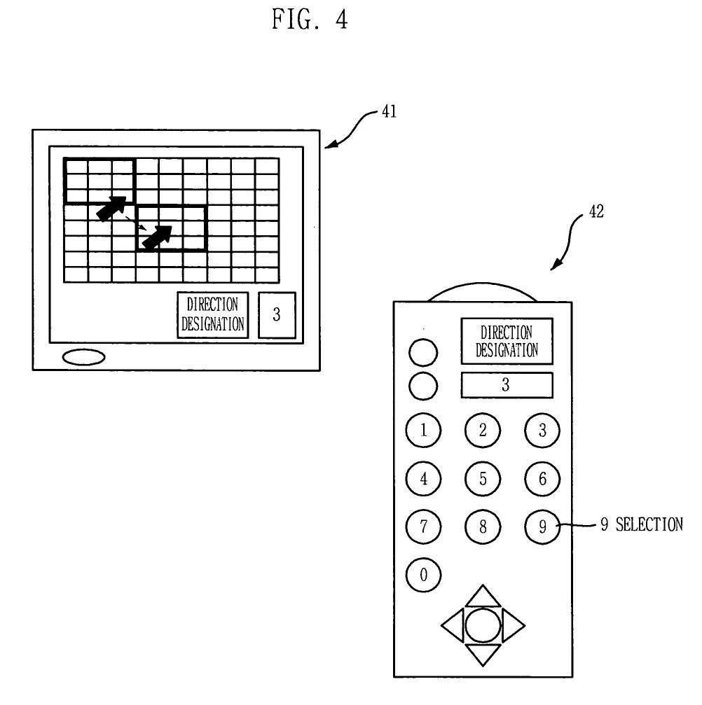

FIG. 4 shows movement of a character's position according to direction designation in accordance with an embodiment of the present invention.

The position designation button 12 included in the input device 10 is converted into the “direction designation” function and the motion unit of the motion unit designation button is set up as “3”. State marks of each button are displayed through the position designation displayers 13 and 22, and the motion unit displayers 15 and 23.

A cursor, i.e., the general character, and a rectangular frame, i.e., the designated region, are displayed in a left upper part of the entire screen and the cursor is positioned within the designated region.

When the number buttons 16 or direction buttons 17, i.e., the character motion request signal, are pressed, the cursor and the designated region move as much as the pre-determined motion unit in a direction that the button designates. That is, when “9” among the number buttons 16 is pressed at “42” in a state, which the “direction designation” function is activated, the cursor and the designated region simultaneously move as much as “3”, which is the pre-determined motion unit, in a right lower direction at “41”. As a result, the cursor and the designated region are positioned in a center of the screen. The cursor is shown in a center of the designated region, which is newly displayed.

“1” to “9” of the number buttons 16 means “left upper part”, “upper part”, “right upper part”, “left part”, “central part”, “right part”, “left lower part”, “lower part” and “right lower part”, respectively. 4 kinds of direction buttons 17 mean the arrow directions, respectively.

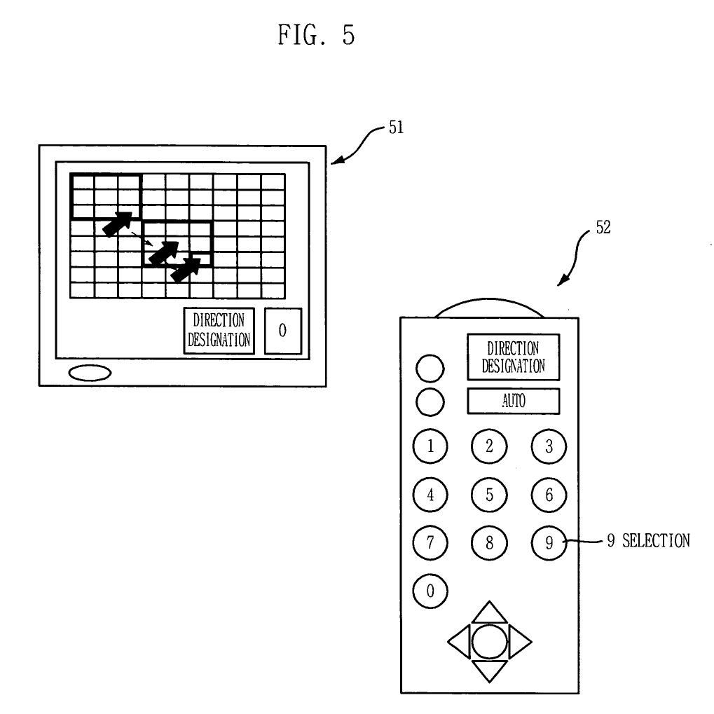

An operation for a case that the motion unit is changed by pressing the motion unit designation button when the cursor and the designated region move as much as “3” in the right lower direction will be described referring to FIG. 5.

FIG. 5 shows movement of the character's position by the motion unit change in a state of the FIG. 4 in accordance with the embodiment of the present invention.

The position designation button maintains the “direction designation” function, but the motion unit is converted into “auto”, i.e., “0” when the motion unit designation button 14 is inputted again. It is displayed through the motion unit displayers 15 and 23.

According to the character motion request signal, i.e., when the number buttons 16 or direction buttons 17 are pressed, the cursor and the designated region positioned in the center of the screen move in a direction that the button designates. Accordingly, a range of the designated region is automatically reduced and the cursor is positioned in the center of the designated region, which is newly displayed. That is, since “9” among the number buttons 16 is pressed once more at “52” in a state that the motion unit is “0”, the designated region is reduced and illustrated in a direction requested within a previous range at “51”. Herein, the state of “0” means that the motion unit is automatically reduced and the requested direction means a right lower direction designated by “9”. More specifically, since “9” is inputted once more in a state that the entire screen is divided into a “3×3” unit, the designated region moves in a right lower direction by being reduced by a third of the region. When the motion unit is changed from “3” into “1”, the designated region is reduced from “3×3” into “1×1”.

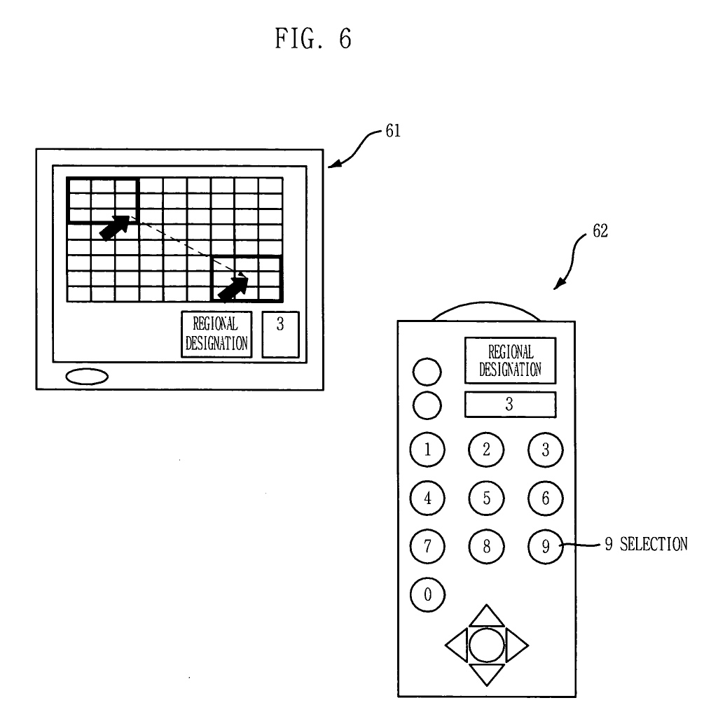

FIG. 6 shows movement of the character's position by the regional designation in accordance with the embodiment of the present invention.

The position designation button 12 is converted into a “regional designation” function and the motion unit is set up as “3” according to re-input of the motion unit designation button 14. State marks of each button are displayed through the position designation displayer 13 and 22, and the motion unit displayer 15 and 23, respectively.

When the character motion request signal is inputted, the cursor and the designated region simultaneously move in a requested direction. It is opposite to progressive movement. Since the motion unit is set up as “3”, the entire screen is divided into the “3×3” unit, and the region unit becomes the motion unit of the cursor and the designated region. Since “9” among the number buttons 16 is inputted at “62”, the designated entire region is positioned in a right lower direction, which is designated by “9” at “61”. The cursor is positioned in a center of a new designated region.

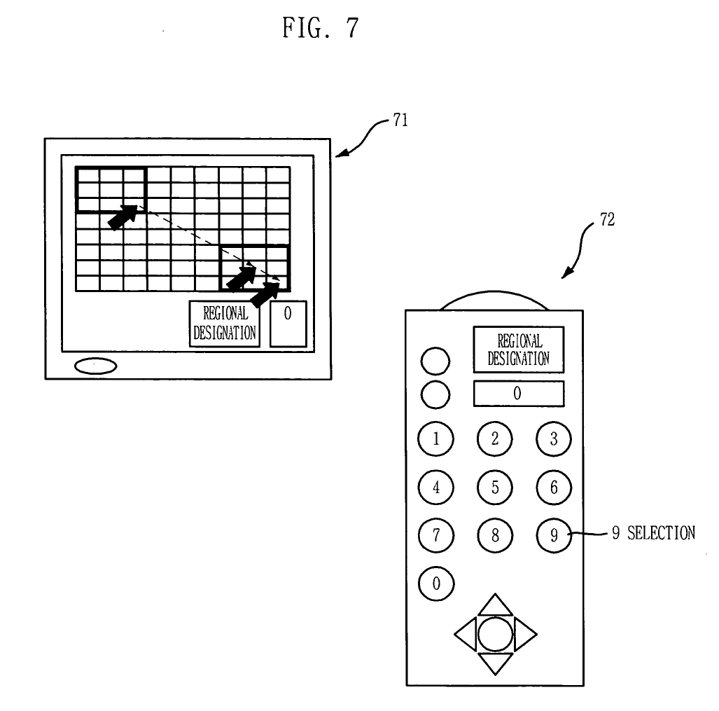

FIG. 7 is a block diagram showing movement of the character's position by the motion unit change in the state of FIG. 6. The position designation button 12 maintains the “regional designation” function and the motion unit is set up as “0” according to re-input of the motion unit designation button 14.

When “9” among the number buttons 16 is inputted once more, the cursor and the designated region are positioned in a right lower part. Since the motion unit is in a state of “0” the designated region moves by being reduced from “3×3” into “1×1”. That is, although the entire screen is divided into “3×3”, “9” among the number buttons 16 is inputted at “72” in the state that the motion unit is reduced into “0”. Accordingly, the cursor and the designated region simultaneously move in a right lower direction. Herein, the designated region is reduced as much as a unit of the reduced region at “71”. Each cursor is positioned in a center of the new designated region.

The character positioning system 30 of the present invention can easily control the character on screen through the limited number of buttons by assigning dynamic functions to a plurality of buttons included in the input device 10 in a state that the character positioning system 30 is connected to the input device 10, such as a remote controller and a joy stick, and the output device 20 capable of screen display, and having the control command inputted through button arrangement.

The present invention can diversely control motions of the character based on the limited buttons by assigning dynamic functions to the buttons and having the control command inputted through the button arrangement.

As described in detail, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art of the present invention, further description will not be provided herein.

The present application contains subject matter related to Korean patent application No. 2005-0121167, filed with the Korean Intellectual Property Office on Dec. 9, 2005, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A character positioning system, comprising:
a command data analyzing means for analyzing an input signal received from an input device to generate an analysis result and performing a control command based on the input signal;
a positioning means for receiving the analysis result for the input signal from the command data analyzing means and controlling a character motion on screen based on the analysis result; and
a position information storing means for storing position information of a character on screen.

2. The system as recited in claim 1, wherein the command data analyzing means analyzes the input signal, converts a setting function for a corresponding button of the input device when the input signal is a function state conversion request signal, and transmits the analysis result to the positioning means when the input signal is a character motion request signal.

3. The system as recited in claim 2, wherein the command data analyzing means mutually converts the setting function of the input signal for a position designation button of the input device from direction designation to regional designation, or from the regional designation to the direction designation if the input signal is a signal for the position designation button among the function state conversion request signals.

4. The system as recited in claim 2, wherein the command data analyzing means sets up a predetermined number as an input signal for a motion unit designation button of the input device, i.e., a motion unit, if the input signal is a signal for the motion unit designation button among the function state conversion request signal.

5. The system as recited in claim 2, wherein when the positioning means receives the analysis result for the character's position designation request signal from the command data analyzing means, the positioning means controls a character motion based on the analysis result and position information of a character on screen, which is stored in the position information storing means.

6. The system as recited in claim 5, wherein the positioning means controls motions of a general character including a cursor and a designated region.

7. The system as recited in claim 6, wherein when the positioning means moves the character in a direction according to the input signal generated by a number button and a direction button of the input device, the positioning means moves coordinates of the character based on the motion unit, which is currently set.

8. The system as recited in claim 6, wherein when the present motion unit is set up at a predetermined value, the positioning means extends/reduces the designated region at the predetermined value in a direction according to the signal generated by the number button of the input device.

9. The system as recited in claim 7, wherein when the motion of the designated region is controlled, the positioning means positions the cursor in a center of a designated new region.

10. A character positioning method of a character positioning system, comprising the steps of:
a) receiving an input signal from an input device;
b) analyzing the input signal to generate an analysis result and determining a control command;
c) when the input signal is a function state conversion request signal, mutually converting a setting function for a corresponding button; and
d) when the input signal is a character motion request signal, controlling a motion of a character based on position information of the character on screen and the analysis result.

11. The method as recited in claim 10, wherein in the step c), the setting function of a position designation button is mutually converted from direction designation to regional designation or from the regional designation to the direction designation in case of the input signal for the position designation button.

12. The system as recited in claim 10, wherein in the step c), a next predetermined number is set up as a value for a motion unit designation button, i.e., a motion unit, if the input signal is a signal for the motion unit designation button.

13. The system as recited in claim 10, wherein in the step d), motions of a general character including a cursor and a designated region are controlled.

14. The system as recited in claim 13, wherein in the step d), when the character is moved in a direction according to the signal for a number button and a direction button, coordinates of the character are moved based on a motion unit, which is currently set.

15. The system as recited in claim 13, wherein in the step d), when the present motion unit is set up at a predetermined value, the designated region is extended/reduced in a direction following the input signal for the number button.

16. The system as recited in claim 14, wherein in the step d), when the motions of the designated region are controlled, the cursor is positioned in a center of a new designated region.
